(19) United States
(12) Patent Application Publication
(10) Pub. No.: US 2001/0051960 A1
(43) Pub. Date: Dec. 13, 2001

(54) Methods and systems for conducting due diligence

(76) Inventors: Ronald S. Kubick, Newtown, CT (US); Preston H. Abbott, Guilford, CT (US); James F. Hogan JR., Rowayton, CT (US); James C. Chang, Stamford, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,392

(22) Filed: Mar. 28, 2001

Related U.S. Application Data
(60) Provisional application No. 60/197,143, filed on Apr. 14, 2000.

(51) Int. Cl. G06F 17/00

(52) U.S. Cl. 707/515; 707/506

(57) ABSTRACT

Methods and systems for conducting due diligence are described. In one embodiment, the method comprises identifying data that will be used to assemble at least one standard documentation file, at least one data collector to collect the identified data and a time for collection of the identified data. The identified data is received and stored and the effectiveness of the data collection is evaluated. The standard documentation file is then assembled.

### CROSS REFERENCE TO RELATED APPLICATIONS

This application claims the benefit of U.S. Provisional Application No. 60/197,143, filed Apr. 14, 2000, which is hereby incorporated by reference in its entirety.

### BACKGROUND OF INVENTION

The present invention relates generally to conducting due diligence and more specifically to computer-based systems and methods for conducting due diligence.

Businesses engaging in complex deals, such as commercial financing, mergers, acquisitions and real estate transactions, generally conduct a due diligence analysis to validate the assets and liabilities of the other party. Typically, external legal counsel participates in the due diligence as well.

During a due diligence analysis, information is gathered from many sources. The information is often complex and relevant to various areas of the overall transaction. Therefore, a number of different members of a due diligence team may need to know the same information. Internal deal teams typically manually and individually collect data as part of the due diligence analysis. For example, in a transaction involving the financing or lease of collateral, both an underwriting team and a legal team are involved. The underwriting team is concerned with what the collateral is, the value of the collateral, and how the collateral is valued. The legal team may only be concerned with the location of the collateral. During the documentation stage, external legal counsel will generally request information from the individual internal deal teams that is necessary to complete the documentation.

Known methods for conducting due diligence are not always time efficient. Individual collection by various internal deal teams increases the risk of overlapping data collection. Further, individual reporting by the internal deal teams to external counsel increases the risk of providing inconsistent or incomplete data to external legal counsel during the documentation process, which results in increased cycle time and costs. For example, in the transaction involving the financing or lease of collateral described above, external legal counsel may request information relating to the location of the collateral from the underwriting deal team. The underwriting deal team will therefore request additional information from the borrower regarding the location of the collateral. Because the information is collected both manually and individually, the underwriting deal team has no knowledge that the data has been previously collected by the legal team. Consequently, documentation cycle time and costs are increased.

Moreover, the effectiveness of the data collection depends on the experience and knowledge of the employees. However, known methods and systems generally do not provide evaluation of the data collection process as a whole.

### SUMMARY OF INVENTION

In one aspect, a method for conducting due diligence is provided which comprises the steps of identifying data that will be used to assemble at least one standard documentation file and identifying at least one data collector to collect the identified data. The data is received and stored and at least one standard documentation file is then assembled using the data.

In another aspect, a computerized system for conducting due diligence is provided. The computer is configured to prompt a user to identify data to be used in a standard documentation file and prompt a user to identify at least one data collector to collect the identified data. The computer further receives and stores the data and generates at least one standard documentation file.

In yet another aspect, a database is provided which comprises data corresponding to at least one identified collector, data corresponding to a time for collection of identified data for a standard documentation file and data corresponding to the standard documentation file.

In still another aspect, a system is provided which comprises a server configured to prompt a user to identify data that will be used to assemble at least one standard documentation file, at least one data collector to collect the data and a time for collection of the data. The system further comprises a database including data corresponding to a due diligence checklist.

In a further aspect, a method for conducting due diligence is provided which comprises using an electronic interface to select data to be used to form at least one standard documentation file, select at least one data collector to collect the data, and request a standard documentation file.

In another aspect, an apparatus comprises means for prompting a user to identify data to be used to form at least one standard documentation file, means for prompting a user to identify at least one data collector to collect the identified data, means for receiving and storing the identified data, and means for generating at least one standard documentation file.

A computer-readable medium is also provided in a further aspect, the medium comprising at least one record of identified data for forming a standard documentation file, a record of at least one identified data collector; and a plurality of rules for using the data to generate a standard documentation file.

### BRIEF DESCRIPTION OF DRAWINGS

FIG. 1 is a system block diagram.

FIG. 2 is a diagram of a network based system.

FIG. 3 is a flow chart diagramming one embodiment of a method of conducting due diligence.

FIG. 4 is a representation of a pre-proposal information request list.

FIG. 5 is a representation of a contents list for a pre-closing credit file.

FIG. 6 is a representation of a typical contents list for a legal documentation file.

FIG. 7 is a data diagram of a loan process flow, including due diligence.

### DETAILED DESCRIPTION

In one aspect, a method for conducting due diligence provides a standard data collection process that is efficient and consistent. The method reduces the cycle time for documentation of a transaction, reduces the potential for providing inconsistent or incomplete data to outside counsel during the documentation process and facilitates evaluation of the data gathering process as a whole.

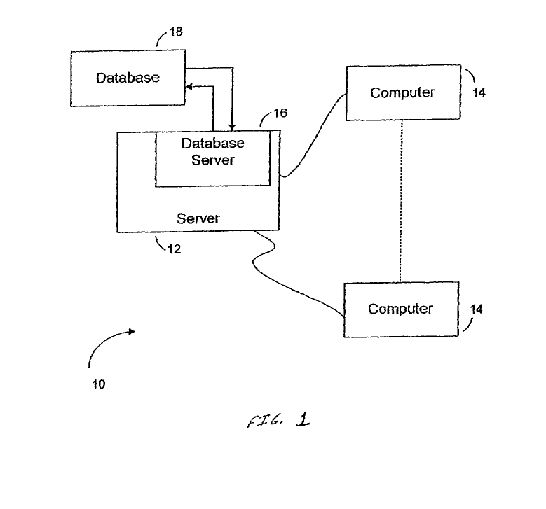

More specifically, FIG. 1 is a block diagram of a system 10 that includes a server sub-system 12, sometimes referred to herein as server 12, and a plurality of devices 14 connected to server 12. In one embodiment, devices 14 are computers including a web browser, and server 12 is accessible to devices 14 via a network such as an intranet or a wide area network such as the Internet. In an alternative embodiment, devices 14 are servers for a network of devices.

Devices 14 are interconnected to the network, such as a local area network (LAN) or a wide area network (WAN), through many interfaces including dial-in-connections, cable modems and high-speed lines. Alternatively, devices 14 are any device capable of interconnecting to a network including a web-based phone or other web-based connectable equipment. Server 12 includes a database server 16 connected to a centralized database 18. In one embodiment, centralized database 18 is stored on database server 16 and is accessed by users at one of devices 14 by logging onto server sub-system 12 through one of devices 14. In an alternative embodiment centralized database 18 is stored remotely from server 12.

In one embodiment, server 12 is configured to identify data that will be used to form at least one standard documentation file, at least one data collector to collect the identified data and a time for collection of the identified data. Server 12 is also configured to receive and store the identified data, evaluate the effectiveness of the data collection and assemble the standard documentation file. The interface allows the user to input data and receive the standard documentation file output.

Each device 14 includes an interface for communicating with server 12, for example, a web browser. The interface allows a user to input data and to receive a standard documentation file output. A computer-based tool for conducting due diligence, as described below in more detail, is stored in server 12 and can be accessed by a user at server 12 or any one of devices 14.

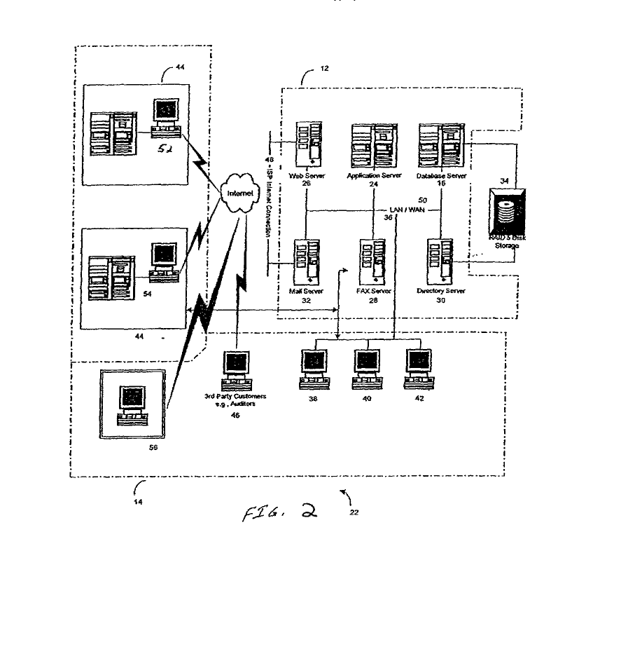

FIG. 2 is a detailed block diagram of a network based system 22. System 22 includes server sub-system 12 and devices 14 (both shown in FIG. 1). Server sub-system 12 includes database server 16, an application server 24, a web server 26, a fax server 28, a directory server 30, and a mail server 32. A disk storage unit 34 which includes a computer-readable medium including records of data and rules for manipulating the data is coupled to database server 16 and directory server 30. Servers 16, 24, 26, 28, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each workstation 38, 40, and 42 is a personal computer including a web browser. Although the functions performed at the work stations typically are illustrated as being performed at respective work stations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server sub-system 12 is configured to be communicatively coupled to various individuals or employee users 44 and to third party users, e.g., customers, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee user 44 or customer user 46 having a work station 52 can access server sub-system 12. One of devices 14 includes a work station 54 located at a remote location. Work stations 52 and 54 are personal computers including a web browser. Also, work stations 52 and 54 are configured to communicate with server sub-system 12. Furthermore, fax server 28 communicates with employee users 44 and customer users 46 located outside the business entity and any of the remotely located customer systems, including a customer system 56 via a telephone link. Fax server 28 is configured to communicate with other work stations 38, 40, and 42 as well.

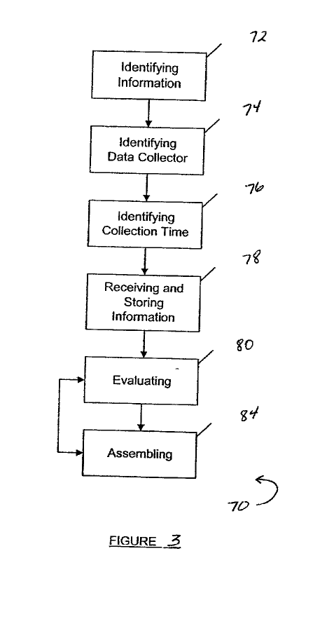

A method of conducting due diligence including a standard data collection process is provided and implemented in systems 10 and 22 described above. Referring to FIG. 3, a flow chart 70 for process steps executed in the present method of conducting due diligence is shown. More specifically, system 10 (shown in FIG. 1) identifies 72 information or data that will be used to assemble a standard documentation file for use during the documentation stage of a transaction. In one embodiment, the data is identified 72 in accordance with a knowledge base. The knowledge base may be stored within a database. The knowledge base is used to automatically identify 72 data that will be used to form a particular documentation file for a particular deal. The knowledge base includes any data relevant to identifying 72 the appropriate data that will be used to form at least one standard documentation file. Because each transaction is somewhat different, the identified data varies by deal or transaction. Accordingly, the data may include, but is not limited to data associating specific data types to specific types of transactions. The knowledge base also includes data received during due diligence and recommendations provided by external deal teams and internal deal teams. As used herein, external deal teams are teams of persons responsible for certain aspects of the overall transaction that are not employees of the company engaging in the business transaction. Examples of external deal teams include, but are not limited to external legal counsel and external accounting firms. Data received during due diligence is discussed in more detail below.

System 10 identifies 74 a data collector. The data collector may be any person or tool suitable for collecting the identified data. In one embodiment, system 10 is configured to identify 74 a data collector in accordance with a knowledge base. A knowledge base is used to automatically identify 74 a data collector. The knowledge base is stored within a central database. In an alternative embodiment, the knowledge base includes any data beneficial to identification 74 of a data collection person or tool. The data includes data associating certain types of data with specific data collectors. For example, capital expenditure data is associated with the new customer origination deal team. The identification 74 of a data collector reduces the risk of redundant data collection and consequently the collection efforts are more efficient.

System 10 then identifies 76 a collection time in accordance with a knowledge base. A knowledge base is used to automatically identify 76 a collection time. In one embodiment, the knowledge base is stored within a central database. In an alternative embodiment, the knowledge includes any data beneficial to identification 76 of a data collection time. The data includes data associating a specific type of data with a specific collection time. For example, in commercial real estate transactions, the collection time for collection of data relating to a borrower's assets would be associated with the time of proposal acceptance. It should be recognized, however, that time sensitive data, or data that experiences continual change, is received and stored 78 more than one time if the data changes such that it is inaccurate at the time of documentation. One example of time sensitive data is a borrower's credit rating.

After the data is identified 72, a data collector is identified 74 a collection time is identified 76, and the data is received and stored 78. In one embodiment, the data is received and stored 78 into a central database. The database includes any information relevant to the transaction including data collected during due diligence. In a specific embodiment, data may be received and stored 78 into a central database from other databases on system 10 (shown in FIG. 1). After the data is collected, the data collection is evaluated 80. Data may be evaluated 80 at any stage of due diligence.

In an exemplary embodiment, data collection is evaluated 80 after each stage of the due diligence process. Such evaluation may include determining a present completion percentage of the standard documentation file, the percentage of data passed between underwriting and approval and legal, and the percentage of usable data provided by underwriting and approval. In one embodiment, evaluation 80 is accomplished by use of a microprocessor. In an alternative embodiment, evaluation 80 is accomplished manually. The term microprocessor, as used herein, refers to controllers, microcontrollers, programmable logic controllers, input/output (I/O) controllers or any other processor capable of processing for the embodiments described herein.

In one embodiment, evaluation 80 is accomplished manually. In such an embodiment, any person including a deal team leader may conduct evaluation 80. For example, underwriting may evaluate 80 the completeness of the information received from the individual internal deal teams. In a further example, underwriting evaluates 80 its own data collection efforts. In addition, after the standard documentation file is assembled 84, it is evaluated 80 for completion and accuracy.

Determination of the present completion percentage of the standard documentation file, percentage of data passed between underwriting and approval and legal, and percentage of usable data provided by underwriting and approval is determined by any known method. In one specific embodiment, the percent of completion of the standard documentation file is determined as (a number of items collected divided by a number of total items collected)*100.

In yet another embodiment, the percentage of data passed between underwriting and approval and legal is determined as (actual number of items in the standard documentation file divided by an expected number of items in the standard documentation file)*100.

In a further embodiment, the percent of usable data provided by underwriting and approval is determined as (actual number of accurate documentation items divided by an expected number of documentation items)*100.

After the identified data is received and stored 78 and the data collection is evaluated 80, a standard documentation file is assembled 84. Documents relevant to a transaction are assembled 84 to form a standard documentation file. Assembling 84 is accomplished by any known means of assembling documents. Examples of known means of assembling 84 documents include, but are not limited to manual assembly, the use of a computer or computer software configured for assembling documents, the use of document generating systems or software and the use of data management software or systems.

The standard legal documentation file, in one embodiment, is assembled 84 in accordance with a knowledge base. The knowledge base is used to automatically assemble 84 the documents that form the standard documentation file. The knowledge base includes any data relevant to assembling 84 a standard legal documentation file. The data includes data associating a particular standard documentation file with documents to be included within that particular standard documentation file. For example, the knowledge base includes data associating a standard pre-closing file with an audit report, a most recent accounts receivable (A/R) aging and data relating to the top ten customers by sales volume for the last 12 months. In an alternative embodiment, the standard documentation file is assembled 84 using data stored and received 78 within a central database.

Identified data may be received and stored 78 (shown in FIG. 3) from any source. In one embodiment, discussed briefly above, identified data may be received 78 from data collected during due diligence. Typically, due diligence comprises the new customer origination, auditing, and underwriting and approval stages. In one embodiment, data received and stored 78 may include, but is not limited to, data relating to capital structure, corporate structure, marketing and industry data. Data received and stored 78 is compiled in a checklist. The checklist is a knowledge base, which includes specific data or information to be gathered during the various stages of due diligence. Descriptions set forth in Appendix A, titled Master Due Diligence Checklist, are descriptions of some of the data included within the knowledge base.

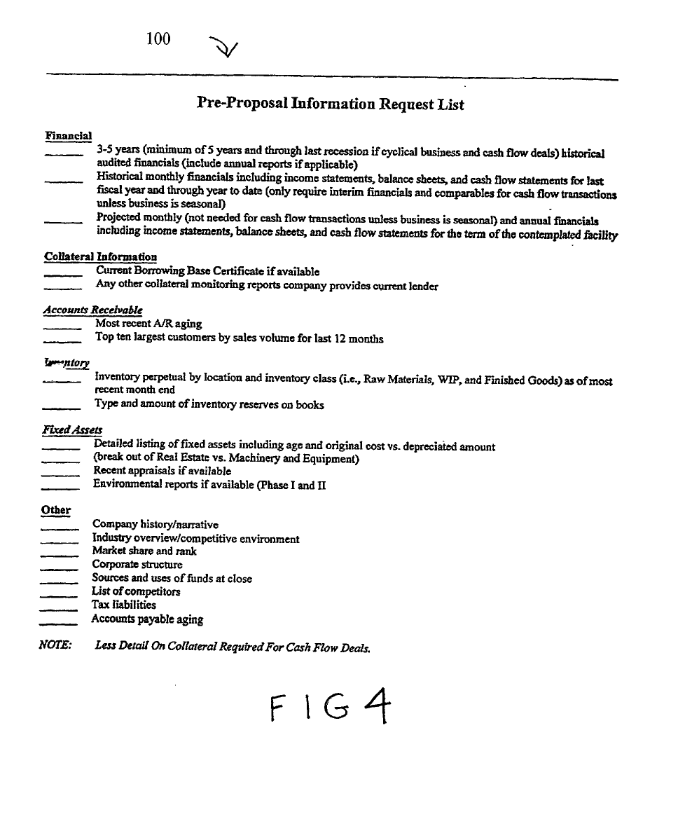

Additional information is received and stored 78 from a party to the transaction to expedite documentation. In one embodiment, additional information is any data to be included in a standard documentation file including data that is not generally collected during due diligence. A typical loan documentation questionnaire to be utilized to expedite documentation is described in Appendix B. In addition, FIG. 4 is a representation of a typical pre-proposal information request list 100 that is utilized in accordance with the present embodiment to expedite documentation.

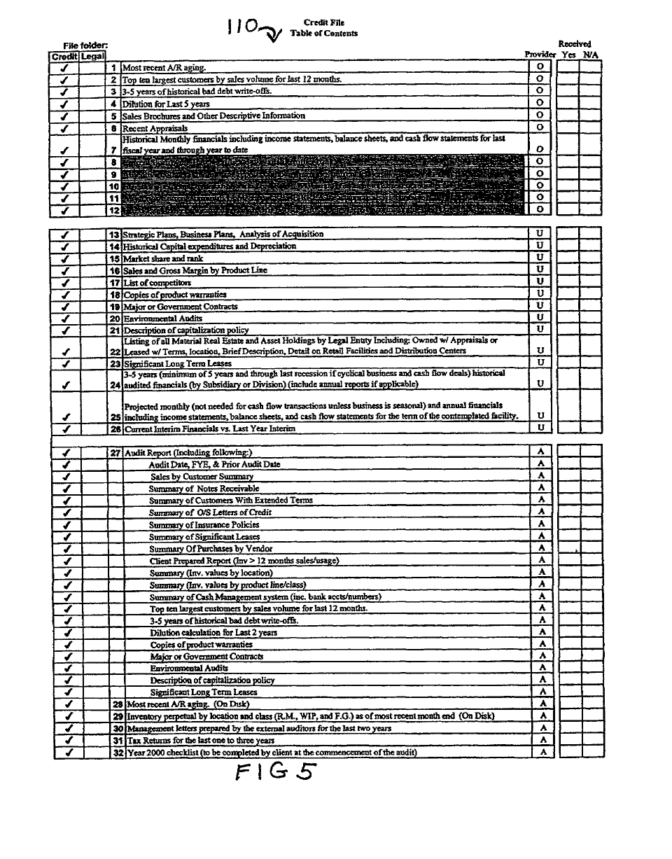

Any standard documentation file may be assembled 84 in accordance with the methods described herein. In one embodiment, a pre-closing credit file is assembled. More specifically, FIG. 5 is a representation of a typical table of contents 110 for a standard pre-closing credit file that is assembled 84 (shown in FIG. 3). The pre-closing credit file includes any data relevant to the pre-closing stages of the transaction. For example, the pre-closing credit file provides the foundation for a post-closing credit file.

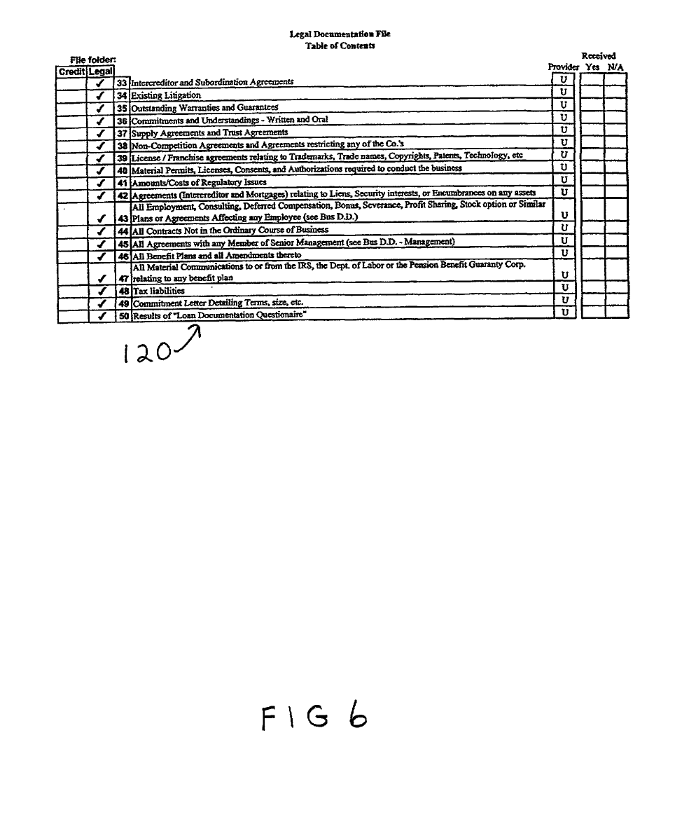

In an alternative embodiment, a legal documentation file is assembled 84 and includes any data relevant to the legal documentation phase of the transaction. Specifically, FIG. 6 is a representation of a typical table of contents 120 for a standard legal documentation file assembled 84 using system 10 (shown in FIG. 1).

In one embodiment, the standard documentation file is transferred to external deal teams. In a specific embodiment, the standard documentation file is transferred to external legal counsel during an initial meeting to streamline documentation. The first meeting with external legal counsel is typically at the start of the documentation process. Standard documentation files that may be assembled 84 and transferred include a pre-closing credit file and a legal documentation file.

In a specific embodiment, after the standard documentation file is transferred to external deal teams, external deal teams evaluate 80 the effectiveness of the data collection procedures. Evaluation 80 is accomplished in the same manner of evaluating 80 discussed above. Evaluation 80 is used to improve the data collection procedures as part of the overall due diligence process.

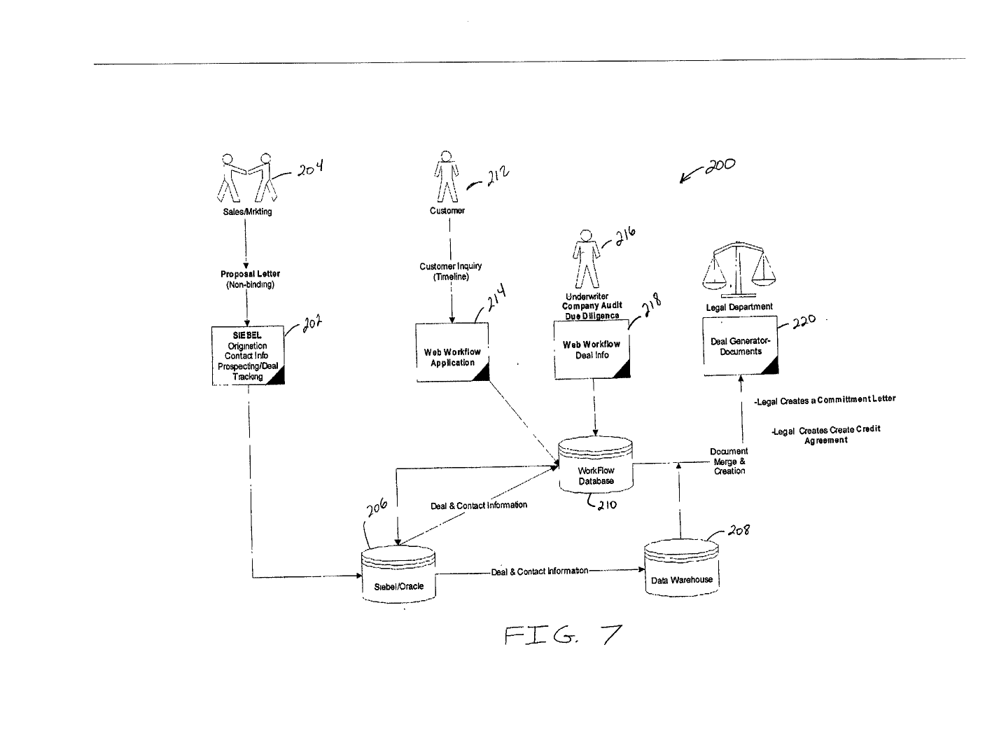

FIG. 7 is a data diagram 200 of a loan process flow, including due diligence. Referring specifically to the Figure, to begin a deal process, origination data, contact information and deal tracking information 202 is entered into a system, for example, system 10 (shown in FIG. 1) or system 22 (shown in FIG. 2) by a user 204, for example, a sales/marketing user. Information 202 is stored within system 10 in a database 206. Database 206 is configured to provide deal and contact information to both a data warehouse 208 and a workflow project database 210. A customer 212 has an ability to track deal activity, by inquiring to a workflow application 214 that is accessible via the internet to registered customer users. Customer 212 is able to access deal information stored in database 210. A company underwriter 216 performs auditing functions and due diligence by accessing workflow database 210 using a workflow application 218, similar to workflow application 214, but configured for underwriter users, rather than customer users.

Deal and contact information stored in data warehouse 208 and customer and underwriter supplied deal data from workflow database 210 are used to generate due diligence documents for a legal department using document generator 220. Data stored within data warehouse 208 further includes archived deal data, which is surveyed as new deals are being formed within databases 206 and 210, for historical references, perhaps on a borrower or perhaps for historical deal structuring that is useful in preparation of new deal documents.

While the invention has been described in terms of various specific embodiments, those skilled in the art will recognize that the invention can be practiced with modification within the spirit and scope of the claims.

1. A method for operating a computer to conduct due diligence, said method comprising:
prompting a user to identify data to be used to form at least one standard documentation file;
prompting a user to identify at least one data collector to collect the identified data;
receiving and storing the identified data; and
generating at least one standard documentation file.

2. A method according to claim 1 wherein said step of prompting a user to identify data to be used further comprises the step of identifying a time for collection of the identified data.

3. A method according to claim 1 wherein said step of receiving and storing the identified data further comprises the step of storing the data in a database.

4. A method according to claim 1 wherein said step of receiving and storing the identified data further comprises the step of evaluating the effectiveness of collection of the identified data.

5. A method according to claim 4 wherein said step of evaluating the effectiveness of collection comprises the step of determining a percentage of completion of the standard documentation file.

6. A method according to claim 5 wherein the percentage of completion is determined according to (number of items collected/number of total item collected)*100.

7. A method according to claim 1 wherein said step of receiving and storing the identified data comprises the step of receiving the identified data from data collected during one of customer origination, auditing and underwriting and approval.

8. A method according to claim 1 wherein said step of assembling at least one standard documentation file comprises the step of generating at least one of a pre-closing credit file and a legal documentation file.

9. A method according to claim 1 further comprising the step of transferring at least one standard documentation file to external deal teams.

10. A method according to claim 4 wherein said step of evaluating the effectiveness of collection of the identified data comprises the step of determining at least one of a percent of data passed between underwriting and legal, a percent of usable data provided by underwriting and approval and a present percent of completeness of the standard documentation file after each stage of due diligence.

11. A method according to claim 10 wherein the percent of data passed between underwriting and approval and legal is calculated according to (actual number of items in the standard documentation file divided by an expected number of items in the standard documentation file)*100.

12. A method according to claim 10 wherein the percent of usable data provided by underwriting and approval is calculated according to (an actual number of accurate documentation items divided by an expected number of documentation items)*100.

13. A method according to claim 1 wherein said step of receiving the identified data comprises the step of receiving the identified data via at least one of the Internet and an Intranet.

14. A computer programmed to:
prompt a user to identify data to be used to form at least one standard documentation file;
prompt a user to identify at least one data collector to collect the identified data;
receive and store the identified data; and
generate at least one standard documentation file.

15. A computer according to claim 14 wherein to prompt a user to identify data to be used, said computer displays a computer generated screen prompting the user to identify a time for collection of the identified data.

16. A computer according to claim 14 configured to receive the identified data and store the identified data in a database.

17. A computer according to claim 14 configured to evaluate the effectiveness of collection of the identified data by determining a percentage of completion of the standard documentation file.

18. A computer according to claim 17 wherein the percentage of completion is determined according to (number of items collected/number of total item collected)*100.

19. A computer according to claim 14 wherein for a standard documentation file said computer configured to generate at least one of a pre-closing credit file and a legal documentation file.

20. A computer according to claim 17 wherein to evaluate the effectiveness of collection of the identified data, said computer is configured to determine at least one of a percent of data passed between underwriting and legal, a percent of usable data provided by underwriting and approval and a present percent of completeness of the standard documentation file after each stage of due diligence.

21. A computer according to claim 20 wherein said computer is configured to calculate the percent of data passed between underwriting and approval and legal according to (actual number of items in the standard documentation file divided by an expected number of items in the standard documentation file)*100.

22. A computer according to claim 20 wherein said computer is configured to calculate the percent of usable data provided by underwriting and approval according to (an actual number of accurate documentation items divided by an expected number of documentation items)*100.

23. A database comprising:
data corresponding to at least one identified data collector;
data corresponding to a time for collection of identified data for a standard documentation file; and
data corresponding to the standard documentation file.

24. A database according to claim 23 further comprising data corresponding to an evaluation of the effectiveness of collected data.

25. A database according to claim 23 wherein said data corresponding to the standard documentation file comprises data documenting a transaction.

26. A database according to claim 23 wherein said data corresponding to the standard documentation file comprises data provided by external deal teams and internal deal teams.

27. A database according to claim 23 further comprising data corresponding to a percent completion of the standard documentation file.

28. A database according to claim 23 wherein said data corresponding to the standard documentation file comprises at least one of data associating a pre-closing file with an audit report, data regarding accounts receivable aging and data relating to a top ten customers by sales volume.

29. A database according to claim 23 further comprising data corresponding to a due diligence checklist.

30. A system for conducting due diligence, said system comprising:
a database comprising data corresponding to a due diligence checklist;
a server configured to prompt a user to identify data that will be used to form at least one standard documentation file, identify at least one data collector to collect the identified data and to identify a time for collection of the identified data.

31. A system according to claim 30 wherein said server configured to receive and store the identified data, evaluate the effectiveness of collection of the identified data and assemble the data into a standard documentation file stored in said database.

32. A system according to claim 31 wherein said server is configured to evaluate the effectiveness of collection of the identified data by determining one of present percent of completeness of the standard documentation file, percent of data passed between underwriting and approval and legal and the percent of usable data provided by underwriting and approval.

33. A system according to claim 32 wherein said server is further configured to determine a percent of completeness of the standard documentation file according to (number of items collected/number of total item collected)*100.

34. A system according to claim 32 wherein said server is further configured to determine a percent of data passed between underwriting and approval and legal according to (actual number of items in the standard documentation file divided by an expected number of items in the standard documentation file)*100.

35. A system according to claim 32 wherein said server is further configured to determine a percent of usable data provided by underwriting and approval according to (an actual number of accurate documentation items divided by an expected number of documentation items)*100.

36. A system according to claim 30 wherein said server is configured for assembling at least one standard documentation file using one of a document generating system or software and a data management software or system.

37. A system according to claim 30 wherein said server is configured for assembling one of a pre-closing credit file and a legal documentation file.

38. A system according to claim 30 wherein said server is configured to receive data via at least one of the Internet and an Intranet.

39. A system according to claim 30 wherein said server is configured to receive and store the data from data collected during one of customer origination, auditing and underwriting and approval.

40. A system according to claim 30 wherein said database comprises at least one of data corresponding to at least one identified collector, data corresponding to a time for collection of identified data for a standard documentation file, and data corresponding to the standard documentation file.

41. A system according to claim 40 wherein said-database comprises data corresponding to an evaluation of effectiveness of collected data.

42. A system according to claim 40 wherein said database comprises data corresponding to a percent completion of the standard documentation file.

43. A system according to claim 40 wherein said data corresponding to the standard documentation file comprises data associating a pre-closing file with an audit report, data regarding accounts receivable aging and data relating to a top ten customers by sales volume.

44. A method for conducting due diligence, said method comprising the steps of:
selecting, from an electronic interface, data to be used to form at least one standard documentation file;
selecting, from the electronic interface, at least one data collector to collect the data; and
requesting, from the electronic interface, a standard documentation file.

45. A method according to claim 44 further comprising the step of selecting, from the electronic interface, a time for collection of identified data.

46. A method according to claim 44 further comprising the step of requesting, from the electronic interface, an evaluation of effectiveness of the collection of the identified data.

47. A method according to claim 46 wherein an evaluation of effectiveness comprises determining a percentage of completion of the standard documentation file.

48. A method according to claim 44 wherein said step of requesting a standard documentation file comprises the step of requesting, from the electronic interface, at least one of a pre-closing credit file and a legal documentation file.

49. A method according to claim 44 further comprising the step of requesting, from the electronic interface, that at least one standard documentation file be transferred to external deal teams.

50. Apparatus comprising:
means for prompting a user to identify data to be used to form at least one standard documentation file;
means for prompting a user to identify at least one data collector to collect the identified data;
means for receiving and storing the identified data; and
means for generating at least one standard documentation file.

51. Apparatus according to claim 50 wherein said means for prompting a user to identify data to be used further comprises means for prompting a user to identify a time for collection of the identified data.

52. Apparatus according to claim 50 wherein said means for receiving and storing the identified data further comprises means for storing the data in a database.

53. Apparatus according to claim 50 wherein said means for receiving and storing the identified data further comprises means for evaluating the effectiveness of collection of the identified data.

54. Apparatus according to claim 53 wherein said means for evaluating the effectiveness of collection comprises means for determining a percentage of completion of the standard documentation file.

55. Apparatus according to claim 50 wherein said means for generating at least one standard documentation file comprises means for generating at least one of a pre-closing credit file and a legal documentation file.

56. Apparatus according to claim 50 further comprising means for transferring at least one standard documentation file to external deal teams.

57. A computer-readable medium, comprising:
at least one record of identified data for forming a standard documentation file;
a record of at least one identified data collector; and
a plurality of rules for using the data to generate a standard documentation file.

58. A computer-readable medium according to claim 57 further comprising a record identifying a time for collection of the data.

59. A computer-readable medium according to claim 57 further comprising a plurality of rules for evaluating effectiveness of collection of identified data.

60. A computer-readable medium according to claim 57 further comprising a plurality of rules for determining a percentage of completion of a standard documentation file.

61. A computer-readable medium according to claim 57 wherein said rules for generating a standard documentation file comprises rules for generating at least one of a pre-credit closing file and a legal documentation file.
